(19) United States
(12) Patent Application Publication
(10) Pub. No.: US 2006/0026891 A1
(43) Pub. Date: Feb. 9, 2006

(54) Easy catch

(76) Inventor: LeRoy A. Witt, Wichita, KS (US)

Correspondence Address: Mr. LeRoy A. Witt, 3200 Carlock, Wichita, KS, 67204, US

(21) Appl. No.: 11/096,707

(22) Filed: Apr. 2, 2005

Related U.S. Application Data
(60) Provisional application No. 60/522,018, filed on Aug. 3, 2004.

(51) Int. Cl. A01K 91/10

(52) U.S. Cl. 43/15

(57) ABSTRACT

A fishing rod holder that, in response to the pull exerted by a fish against a line and tackle, will automatically set the hook by a series of release mechanisms and springs. The device is comprised of an upper and lower assembly to which various elements are attached. All components are fabricated from 0.125 inch steel and are plated for durability and long life. An adjustable tension device allows for the automatic catching of fish within a wide range of weight and species. The device is generally vertical in nature and can be easily transported from place to place.

### CROSS REFERENCE TO RELATED APPLICATIONS

This application is a follow on to Provisional Patent 60/522,018 filed on Aug. 3, 2004. LeRoy A. Witt is the named and sole inventor in both the Provisional Patent and this non-Provisional application. In addition, this device is an improvement on U.S. Pat. No. 4,476,645 which I understand expired for non-payment on Oct. 16, 1998.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Automatic fish catchers and hook-setting rigs have been in use for many years. Various configurations have therefore been suggested. However, the prior art automatic fish catchers are typically complex, cumbersome, ineffective and prone to wear, fatigue and failure. Therefore, an improved automatic fish catcher and hook setting rig is needed.

### BRIEF SUMMARY OF THE INVENTION

The automatic fish catcher and hook-setting rig is described. The rig consists of a lower assembly made of high-grade steel. This lower assembly is preformed into a spade-type shape, and contains the platform to which the adjustable tension spring is attached.

The upper assembly of the main body is welded to the lower assembly. The upper assembly is constructed of high-grade steel and formed into a U-channel. The swing arm is attached to the upper assembly, and conversely, the other end of the swing arm is attached to a rectangular steel tube. This rectangular steel tube holds the fishing pole.

The automatic fish catcher and hook-setting rig is set up by inserting the spade assembly perpendicularly into the ground. Next, the rectangular steel tube is forced downward until the swing arm and swing arm ledge engage in the trigger assembly. Finally the fishing pole handle is inserted into the rectangular steel tube. As fish tug on the tackle or bait of the afore-mentioned fishing pole, a force is transmitted thru the fishing line, into the fishing pole and ultimately into the rectangular tube. This force causes the rectangular tube to move forward and slightly downward. This in turn releases the trigger assembly and allows the dual springs in the upper assembly to sharply move upward and aft, setting the fishhook in the fish.

### BRIEF DESCRIPTION OF THE SEVERAL VIEWS OF THE DRAWING

The present invention is illustrated by way of example, and not limitation, by the figures of the accompanying drawings in which like references indicate similar elements and in which:

FIG. 1 illustrates one embodiment of an automatic fish catcher and hook-setting rig in an uncocked state from a side elevation;

FIG. 2 illustrates one embodiment of an automatic fish catcher and hook-setting rig in an uncocked state from a front elevation;

FIG. 3 illustrates one embodiment of an automatic fish catcher and hook-setting rig from a side elevation in the locked or ready position “A”;

FIG. 4 illustrates one embodiment of an automatic fish catcher and hook-setting rig from a side elevation showing the relationship between the locked or ready position “A” and the engaged or moved positions “B, C & D.”

### DETAILED DESCRIPTION OF THE INVENTION

In the following detailed description of the present invention, numerous specific details are set forth in order to provide a though understanding of the present invention. However, it will be apparent to one skilled in the art that the present invention may be practiced without these specific details.

FIG. 1 illustrates one embodiment of an automatic fish catcher and hook-setting rig in an uncocked state from a side elevation.

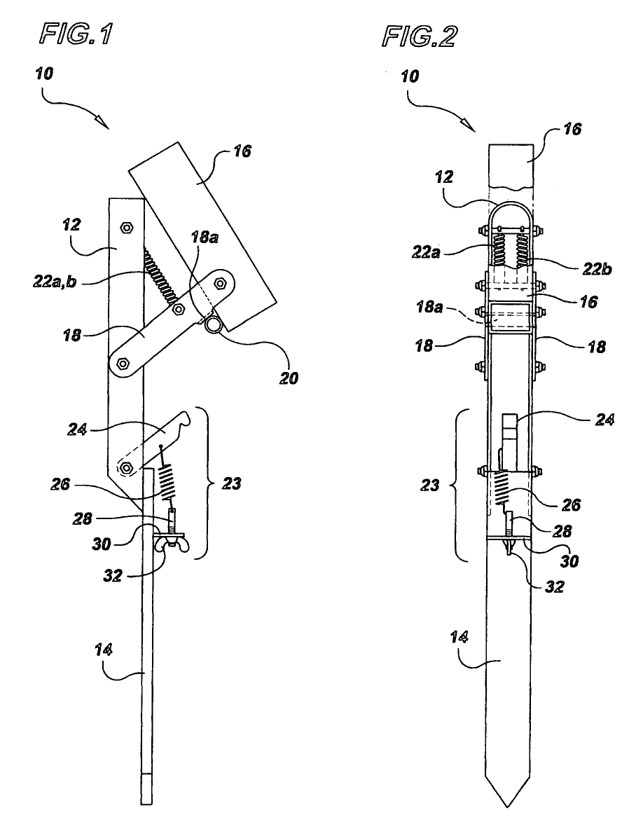

FIG. 2 illustrates one embodiment of an automatic fish catcher and hook-setting rig in an uncocked state from a front elevation.

Referring to FIG. 1 and FIG. 2, the invention is comprised of two major components to which various sub-components are attached. All major components and sub-components are cad plated for long life and corrosion resistance. The major components are the Lower Assembly (alternately referred to as a steel ground peg or spade) 14. This lower assembly is welded to the Upper Assembly 12 by means of electric welding. Attached to the lower assembly by means of electric welding is the Platform 30 that hold the adjustable pressure nut. Attached to the upper body by means of pivot pins are the Trigger Mechanism 24 and the Swing Arms 18. Additionally, the springs 22a,b are attached to the Upper Assembly 12 by means of pivot pins.

The Swing Arms 18 are formed from a flat plate steel of approximately 0.125 inch thick into an “H” assembly. Integral with the Swing Arm is Ledge 18a, which contacts Trigger Assembly 24 and keeps the Rectangular Steel Tube 16 in a locked position. Attached to the upper end of the Swing Arms 18 is the Rectangular Steel Tube 16, which is free to pivot about a limited range of travel by means of additional pivot pins. Welded to the bottom side of this tube is a hammer 20 constructed of 0.125 inch rolled steel.

The Trigger Assembly 24 is connected to the Adjustable Pressure Nut 28 by means of the Trigger Mechanism Spring 26. Spring tension, and hence pressure required to release the Trigger Mechanism, is controlled by rotation of the Wing Nut 32 in either a clockwise or counter clockwise direction. Rotating the Wing Nut 32 in a clockwise direction (as viewed from the bottom) increases the spring tension and force required to unseat the ledge 18a from the trigger mechanism. In this manner the pull required from the fish to set the hook is adjustable over a wide range of weights and species.

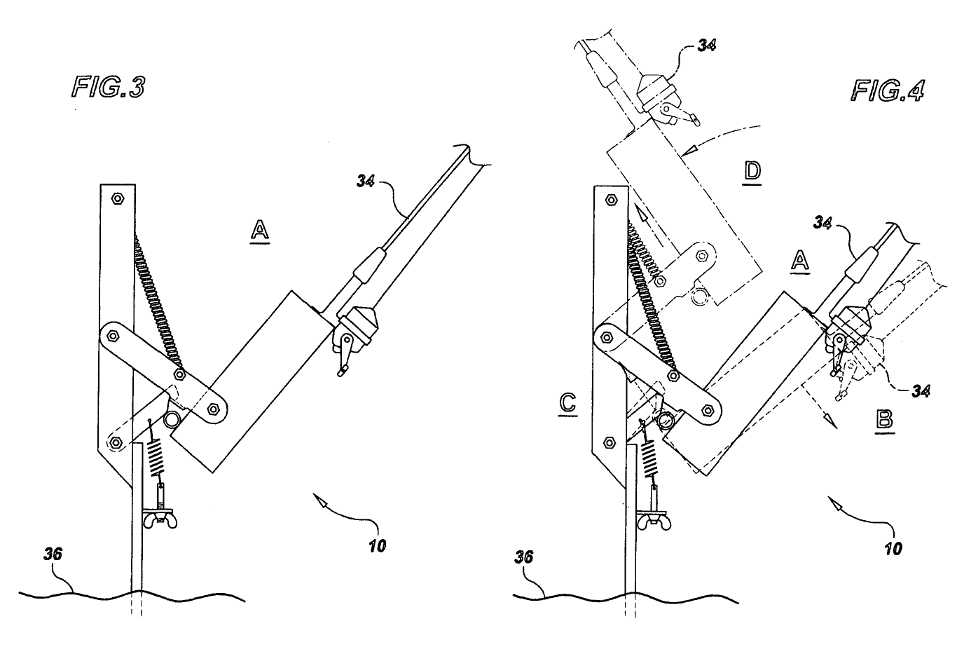

FIG. 3 illustrates one embodiment of an automatic fish catcher and hook-setting rig from a side elevation in the locked or ready position “A.”

Referring to FIG. 3, the automatic fish catcher and hook-setting rig is illustrated in Position A with the trigger locked, or in the ready to release position. A typical fishing pole 34 is shown in the rectangular steel tube. Additionally, the Lower Assembly 14 is shown driven approximately 12 inches into the ground.

FIG. 4 illustrates one embodiment of an automatic fish catcher and hook-setting rig from a side elevation showing the relationship between the locked or ready position “A” and the engaged or moved positions “B, C & D.”

Referring to FIG. 4, “A” shows the rig in the locked position. “B” is illustrative of the position when a fish exerts pressure on the fishing pole and causes the Swing Arms 16 to pivot downward. “C” is the response caused by position “B” which engages the Hammer 20 against the Trigger 24 until the trigger releases the Swing Arm.

“D” is the response caused by position “C” which causes the pole holder (Rectangular Steel Tube 16) and typical fishing pole 34 to jerk back quickly, aided by Tension Springs 22a,b.

In the foregoing specification, the invention has been described with reference to specific exemplary embodiments thereof. It will, however, be evident that various modifications and changes may be made thereto without departing from the broader spirit and scope of the invention as set forth in the appended claim. The specification and drawings are, accordingly, to be regarded in an illustrative sense rather than a restrictive sense.

1.) An automatic fish catching and hook-setting rig comprising:
a lower Assembly to which are mounted a platform for anchoring and supporting the adjustable trigger tension mechanism approximately 9.5 inches from the bottom;
an upper assembly to which are mounted various swing arms, trigger mechanisms and tension springs, with 0.25 inch diameter pivot holes located at 1.0 inch, 4.5 inches, and 9.0 inches from the lower end;
a trigger mechanism machined from 0.50 inch square tubular steel and secured to the upper assembly by means of pivot pins;
a hammer permanently affixed by means of electrical welding to the rectangular steel tube which is used to hold a fishing pole;
a Swing Arm fabricated from 0.125 inch steel, formed into an H channel and containing an integral ledge by which the trigger mechanism rests.
